(19) United States
(12) Patent Application Publication
(10) Pub. No.: US 2025/0188730 A1
(43) Pub. Date: Jun. 12, 2025

(54) A SYSTEM FOR MONITORING RODENTS IN A SEWAGE SYSTEM, A MONITORING DEVICE AND METHODS RELATED THERE TO

(71) Applicant: ANTICIMEX INNOVATION CENTER A/S, Helsinge (DK)

(72) Inventors: Claus Bach SØRENSEN, Helsinge (DK); Peter HOHNEN, Tikøb (DK)

(73) Assignee: ANTICIMEX INNOVATION CENTER A/S, Helsinge (DK)

(21) Appl. No.: 18/844,514

(22) PCT Filed: Mar. 9, 2023
(86) PCT No.: PCT/EP2023/056034

§ 371 Date: Sep. 6, 2024

(30) Foreign Application Priority Data
Mar. 10, 2022 (DK) PA202270097

(51) Int. Cl. E03F 7/12; A01K 29/00

(52) U.S. Cl. CPC E03F 7/12; A01K 29/005

(57) ABSTRACT

A system for monitoring rodents in a sewage system, the system including a plurality of monitoring devices placed in manholes of the sewage system, wherein each monitoring device is provided with one or several sensors configured to detect rodents in the sewage system and to generate a sensor data set. A memory configured to hold an identification code, and a data communications module. A server includes a data communications module communicatively connected to the data communication modules of the monitoring devices, wherein the server is configured to receive, from each monitoring device, the sensor data set and the identification code, and based on these data sets identify how populations of rodents move in the sewage system.

### TECHNICAL FIELD

The invention generally relates to pest control. More particularly, it is related to how to monitor rodents in a sewage system.

### BACKGROUND ART

In most cities in the world, rodents, in particular rats, are a problem. Even though pest control has developed during the last decades, severe damages are still today caused by rodents. The damages are not only direct damages, e.g. food being eaten by rodents, but also indirect damages. An example of indirect damages is that restaurants where rats or other rodents have been found need to close down their business due to non-compliance with food safety regulations. Having reliable and efficient pest control is thus important from a wide range of aspects.

During the last few years, digitally connected pest control devices have become increasingly popular. For instance, the SMART solutions developed and marketed by Anticimex™ is one example well-known in the industry of pest control. By having traps and sensors connected to the Internet, continuous monitoring of these are made possible. This has the advantage that the need for manually checking the traps is reduced or in some cases completely removed. In addition, the traps may be provided with dual sensors, a first sensor for detecting that the trap has snapped, and a second sensor for detecting if a rodent is placed in the trap or not. With such set-up it is further made possible to distinguish between true positives, i.e. the trap has snapped and a rodent is present, and false positives, i.e. the trap has snapped, but no rodent is present. Still an advantage with the connected traps and sensors is that the use of biocides can be reduced or in some cases totally avoided.

Even though modern pest control offers sensors and traps enabling remote monitoring, there is still room for improvement. For instance, it would be beneficial to have a better overall view of how rodents are moving over an area over time. It would also be advantageous to be able to predict rodent presence such that measures can be made at an early stage, thereby limiting damages caused by the rodents.

### SUMMARY

It is an object of the invention to at least partly overcome one or more of the above-identified limitations of the prior art. In particular, it is an object to provide a system for monitoring rodents that provide data that can provide a good overall understanding of the rodent populations and their movement in a city. Still further, it is an additional object to provide data based on which reliable predictions can be made.

According to a first aspect a system for monitoring rodents in a sewage system is provided. The system comprises a plurality of monitoring devices placed in manholes of the sewage system, wherein each monitoring device is provided with one or several sensors configured to detect rodents in the sewage system and to generate a sensor data set, a memory configured to hold an identification code, and a data communications module, a server comprising a data communications module communicatively connected to the data communication modules of the monitoring devices, wherein said server is configured to receive, from each monitoring device, the sensor data set and the identification code, and based on these data sets identify how populations of rodents move in the sewage system.

An advantage of having sensor data sets from different monitoring devices sent to a server, is that over time, movements of the rodent populations in the sewage system can be learned, and in doing so, rodent outbreaks can be predicted.

In addition, by using the information about rodent movements in combination with information on how the different manholes are connected to each other, anomalies in the rodent movements may be used for detecting blockages or leakages in the sewage system. This information may be relevant for achieving efficient pest control, but also for detecting problems related to the sewage system itself and how waste water is handled.

The identification code may be linked to a position data set, wherein the position data set comprises information about a geographical position of the monitoring device.

By linking the identification code to the geographical position upon installation, the sensor data sets can easily be linked to locations in the sewage system. This has the advantage that an improved understanding of a condition of the sewage system can be provided at different points of time. The presence or non-presence of rodents, or the level of rodent presence, in different parts of the sewage system may namely be related to pipe breakages, flooding, chemical emissions, changed noise levels and/or other changed conditions in the sewage system that may result in that the rodents are moving within the sewage system, into the system or out from the system. Put differently, the rodents may be seen as information carriers and by observing the rodent activity in different parts of the sewage system, forecasts related to service need of the sewage system may be made. In addition, based on rodent activity data it is also possible to identify a location for a water pipe breakage, since this may result in that water levels are rising, and in turn that rodents in the sewage system will move away from the rising water levels. Since chemical emissions may also result in that the rodents move, it is further possible to identify and locate chemical emissions. In other words, the rodent activity data may not only be relevant for pest control purposes, but also for companies or entities responsible for maintenance of the sewage system. The data may also be relevant for insurance companies, authorities or other stakeholders.

Each monitoring device may be provided with a tag provided with a code linked to the identification code.

By having the tag, which may be a physical tag and/or a digital tag, this may be scanned by an operator using his or her mobile phone when having installed the mounting device in the manhole, and a location of the mobile phone may be determined and linked to the identification code.

The tag may be a tag provided with a QR code linked to the tag, and as an effect the monitoring device, to which the tag is attached, can trigger a step of determining the location of the mobile phone such that this location in turn can be linked to the identity of the monitoring device. In addition to having the location transferred to a server, it is also possible to have an operator identity transferred to the server to be able to log who was responsible for setting up the monitoring device.

Instead of using QR codes, it is also possible to use RFID technology or other near field communication technology for reading the identity of the monitoring device.

The one or several sensors may comprise two or more sensors placed at a distance from each other such that a direction of movement of the rodents can be determined.

By being able to detect not only that the rodent is present, but also in which direction the rodent is moving, more reliable predictions can be made.

The sensors may be PIR (Passive Infra-Red) sensors.

As a complement to the PIR sensors or as an alternative, one or several cameras may be used. By having cameras, it may be possible also to detect individual rodents and by doing so it is made possible to do even more reliable predictions. Direction may be determined by comparing subsequent images.

The one or several sensors may further comprise radar sensors.

By having different types of sensors used in combination, more reliable predictions can be made.

Radar sensors may be beneficial to use due to their energy efficiency as well as their ability to detect in low light conditions.

As an alternative or as a complement, lidar sensors may be used.

The sensors may further comprise one or several microphones or other sound capturing devices for detecting rodent activity. The microphone may be integrated into the monitoring device or it may be placed further down in the manhole such that this is closer to laterals of the sewage system. In case the microphone is not integrated into the monitoring device, communication with the monitoring device may take place via wire or wireless. The rodent activity may be detected by capturing sounds directly made by the rodents, e.g. communication sounds, or it may be detected by capturing sound indirectly made by the rodents, e.g. sounds generated when the rodents are running and/or swimming in the laterals.

The one or several sensors may comprise temperature sensors.

Rodent behavior may be different in different temperatures, and a sudden increase in temperature may result in that the rodents are leaving the sewage systems. Thus, by taking into account the temperature, more reliable rodent outbreak predictions can be made.

The one or several sensors may comprise flow sensors arranged in lateral pipes. These sensor may be sound-based, e.g. ultrasonic sensors, and/or light-based sensors.

By having the flow sensors, information about the flow of water is made available. By having this piece of information as well, more reliable detection of leakages in the sewage system can be made.

The one or several sensors may further comprise a hydrogen sulfide sensor.

Using a hydrogen sulfide sensor may serve the purpose of reducing false positives, that is, incorrectly detected rodent activity. Above a threshold it is namely not possible for rodents to live, and thus by having the hydrogen sulfide sensor included, circumstances where the rodent cannot live can be detected. In addition to reduce the risk of false positives for specific measurements, the possibility of being able to detect circumstances in which the rodents cannot live comes with the advantage that improved training of AI and/or ML based models can be achieved. Thus, the data captured from the sensors during time slots when the hydrogen sulfide level is above the threshold can be used for training the models to more accurately remove false positives.

Since the presence of rodents correlates to decreased levels of hydrogen sulfide under certain conditions, having information about the hydrogen sulfide level in the different manholes will improve the prediction of rodent outbreaks.

For each monitoring device, at least one of the one or several sensors may be configured as a level sensor such that a water level in each manhole is detected.

By having information not only on rodent activity, but also the water level in the different manholes, more reliable predictions can be made. Increased water levels in the manholes may namely force the rodents out of the sewage system.

In case water flow sensors are also used, the combination of rodent activity, water level data, and water flow data can be used for predicting rodent outbreaks. Rodent outbreaks can also be predicted by using the combination of rodent activity and the water flow data.

In addition to monitoring rodents, the monitoring devices may be configured to detect insects, such as American cockroaches, residing in the manholes. The same sensors as are used for detecting the rodents may also be used for detecting the insects, or there may different sensors for detecting the rodents and the insects, respectively. A sensor type that can be used both for detecting the rodents and the insects is the microphone. Another sensor type that can be used both for detecting the rodents and the insects is the radar sensor. For instance, the radar sensor can be used both for detecting the insects crawling on an inside of the manhole and the rodents running in the laterals connected to the manhole.

According to a second aspect a monitoring device for monitoring rodents in a sewage system is provided. The device may comprise
one or several sensors configured to detect rodents in the sewage system and to generate a sensor data set,
a memory configured to hold an identification code, and
a data communications module communicatively connected to a server.

The same features and advantages presented above with respect to the first aspect also apply to this second aspect.

The device may further comprise
an attachment element arranged to interact with an inside surface of a manhole of the sewage system or an underside of a manhole cover arranged to cover the manhole.

The attachment element may be a rod-shaped element arranged to rest on a first and a second protrusion provided on the inside surface of the manhole.

At least one of the one or several sensors may be configured as a level sensor such that a water level in the manhole is detected.

At least one of the one or several sensors may be a water flow sensor such that a water flow rate is measured. These sensors may be using sound waves, such as ultrasonic waves, and/or light waves for measuring the flow rate.

According to third aspect a method for predicting a rodent outbreak in a city is provided. The method may comprise
collecting sensor data sets from a plurality of monitoring devices placed in manholes or sewer pipes of a sewage system, during a data collection period comprising a plurality of sample time slots,
linking the sensor data sets to the manholes,
detecting rodent activity in each manhole during the sample time slots of the data collection phase, and
forecasting, for a future period, based on the rodent activity determined in the manholes during the data collection phase, when and where rodents are forced out of the sewage system.

In line with the features and advantages presented above with respect to the first aspect, an advantage with this third aspect is that reliable rodent outbreak predictions can be made by combining sensor data from different manholes captured over a period of time such that rodent movements can be determined.

The method may further comprise
determining water level sensor data in the manholes during the data collection period, and
wherein the step of forecasting, for the future period, when and where the rodents are forced out of the sewage system are based on the rodent activity detected in the manholes in combination with the water level sensor data determined during the data collection period.

As presented above, by also combining water levels in the different manholes, more accurate predictions of rodent outbreaks can be made.

The method may further comprise
receiving weather forecast data during the data collection period,
determining a weather forecast-water level relationship between the weather forecast data and the water level sensor data in the manholes during the data collection period,
receiving weather forecast data for the future period,
determining weather forecast water levels, for the future period, based on the weather forecast data for the future period and the weather forecast-water level relationship,
wherein the step of forecasting, for the future period, when and where the rodents are forced out of the sewage system are based on the rodent activity detected in the manholes during the data collection period in combination with the weather forecast water levels determined based on the weather forecast data for the future period.

An advantage of also taking into account weather forecast data is that the rodent outbreak prediction can be made more accurately. The method may further comprise
determining water flow data in the manholes during the data collection period, and
wherein the step of forecasting, for the future period, when and where the rodents are forced out of the sewage system are based on the rodent activity detected in the manholes in combination with the water flow data determined during the data collection period.

According to a fourth aspect a method for identifying a position for placing a trap in a sewage system is provided. The method may comprise
collecting sensor data sets from a plurality of monitoring devices placed in manholes of the sewage system, during a data collection period comprising a plurality of sample time slots,
linking the sensor data sets to the manholes,
detecting rodent activity in each manhole during the sample time slots of the data collection phase,
identifying a least two candidate positions for placing a trap in the sewage system,
evaluating, by simulation, effects on rodent populations in the sewage system for the trap placed in the at least two candidate positions for a future period, and
selecting a most promising candidate position of the at least two candidate positions by comparing the effects associated with the at least two candidate positions with pre-set selection requirements, and
identifying the most promising candidate position as the position for placing the trap.

An effect of being able to make predictions on how rodents are likely to move within a sewage system is that it is also made possible to determine where to place a new trap to provide for that the rodent population is controlled.

According to a fifth aspect a method for identifying positions for existing traps in a sewage system is provided. The method may comprise
collecting sensor data sets from a plurality of monitoring devices placed in manholes of the sewage system, during a data collection period comprising a plurality of sample time slots,
linking the sensor data sets to the manholes,
detecting rodent activity in each manhole during the sample time slots of the data collection phase,
receiving positions for the existing traps,
identifying a least two candidate position data sets for placing the existing traps in the sewage system,
evaluating, by simulation, effects on rodent populations in the sewage system for the traps placed in the at least two candidate position data sets for a future period, and
selecting a most promising candidate position data set of the at least two candidate position data sets by comparing the effects associated with the at least two candidate position data sets with pre-set selection requirements, and
identifying the most promising candidate position data sets as the positions for the existing traps.

According to a sixth aspect a method for identifying a blockage in a sewage system is provided. The sewage system comprising a plurality of manholes connected by laterals, said method may comprise
continuously collecting sensor data sets from a plurality of monitoring devices placed in the manholes,
continuously detecting rodent activity in each manhole,
identifying the blockage in a lateral connecting two of the manholes by detecting a decreasing rodent activity in at least one manhole connected to the lateral.

Since a blockage in the lateral connecting two manholes to each other has an effect on the rodent activity in the different manholes, it is possible to detect blockages by continuously monitoring rodent activity. Thus, by using the rodents as information carriers in this way, problems in the sewage systems can accurately and quickly be identified.

According to a seventh aspect a method for identifying a position of an underground leakage in a sewage system is provided. The sewage system may comprise a plurality of manholes connected by laterals. The method may comprise
collecting sensor data sets from a plurality of monitoring devices placed in the manholes over a period of time,
generating a first time series providing rodent activity in each manhole using the sensor data sets over the period of time,
detecting water level sensor data for each manhole,
generating a second time series providing water levels in each manhole using the water level sensor data over the period of time,
identifying the position of the underground leakage in the sewage system by combining the first and second time series.

In addition, the method may further comprise
detecting water flow data in laterals by using flow sensors placed in the laterals,
generating a third time series providing water flows in the laterals using the water flow data over a period of time,
wherein the step of identifying the position of the underground leakage in the sewage system is made by combining the first, second and third time series.

In a similar manner as the blockage can be detected, it is also possible to detect an underground leakage, either causing an inflow of water or an outflow of water. By being able to reliably and quickly detect such leakage, measures can be made quickly to reduce the impact of such leakage. Since a leakage may also provide access for the rodents to new buildings, this is also advantageous from a pest control perspective.

According to an eighth aspect it is provided a method for predicting a pest outbreak. The method may comprise
collecting sensor data sets from at least one monitoring device placed in a sewage system, during a data collection period comprising a plurality of sample time slots,
detecting pest activity in the manhole during the sample time slots of the data collection phase, and
estimating, for a future period, based on the pest activity determined during the data collection phase, a risk of an insect outbreak.

The insect outbreak can be defined as an exponential population growth resulting in that the insects are forced out from the manhole.

The pest outbreak may comprise a rodent outbreak and/or an insect outbreak, the pest activity may comprise rodent activity and/or insect activity, and the sensor data sets may comprise temperature data, water flow data and/or water level sensor data.

The method may further comprise, in case the risk of pest outbreak is above a threshold, transmitting a notification to a user device such that actions can be made to mitigate the risk.

The monitoring device used may be the same monitoring device as is used for performing the method according to the third aspect, the fourth aspect, the fifth aspect, the sixth aspect and/or the seventh aspect.

The sensor data sets collected may further comprise sound data sets and/or radar data sets.

The estimation of the risk of the pest outbreak may be made by using an artificial intelligence (AI) based model, such as a neural network. Training data for such model may be collected from several monitoring devices in different manholes.

Still other objectives, features, aspects and advantages of the invention will appear from the following detailed description as well as from the drawings.

### BRIEF DESCRIPTION OF THE DRAWINGS

Embodiments of the invention will now be described, by way of example, with reference to the accompanying schematic drawings, in which

FIG. 1 generally illustrates a system for monitoring rodents in a sewage system.

FIG. 2 illustrates the system illustrated in FIG. 1, but with water present in laterals.

FIG. 3 illustrates the system illustrated in FIGS. 1 and 2, but with water present in the laterals and in part of the manholes.

FIG. 4 illustrates a monitoring device according to a first embodiment.

FIG. 5 illustrates the monitoring device according to a second embodiment.

FIG. 6 illustrates the monitoring device in further detail.

FIG. 7 illustrates a sewage system depicted on a city map.

FIG. 8 illustrates how data is provided to and from a server of the system illustrated in FIGS. 1, 2 and 3.

FIG. 9 is a flowchart illustrating a method for forecasting a rodent outbreak.

FIG. 10 is a flowchart illustrating a method for identifying a position for a trap.

FIG. 11 is a flowchart illustrating a method for identifying positions for existing traps.

FIG. 12 is a flowchart illustrating a method for identifying a blockage in the sewage system.

FIG. 13 is a flowchart illustrating a method for identifying an underground leakage.

FIG. 14 generally illustrates a system for monitoring rodents and insects in the sewage system.

FIG. 15 is a flowchart illustrating a method for predicting a pest outbreak.

### DETAILED DESCRIPTION

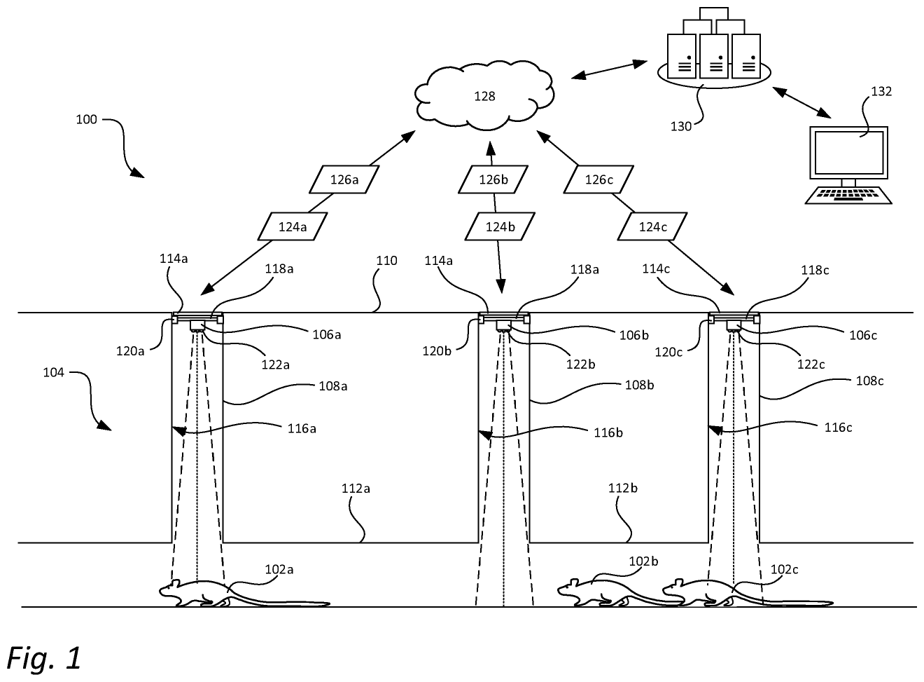

FIG. 1 generally illustrates a system 100 for monitoring rodents 102a-c in a sewage system 104. As illustrated, the system 100 can comprise a plurality of monitoring devices 106a-c placed in manholes 108a-c. The manholes 108a-c, which may be vertical pipes with one end in a ground level 110, can be connected to each other via one or several laterals 112a-b, also referred to as sewer pipes.

The monitoring devices 106-c may be placed in an upper part of the manholes 108a-c such that these easily can be accessed from the ground level 110 by an operator. The monitoring devices 106a-c may be attached to manhole covers 114a-c or alternatively, as illustrated, the monitoring devices may be attached to inside surfaces 116a-c of the manholes 108a-c by using attachment elements 118a-c, e.g. rod-shaped elements interacting with protrusions 120a-c placed on the inside surfaces 116a-c.

The rodents 102a-c moving in the laterals 112a-b of the sewage system 104 can be detected by the monitoring devices 106a-c by using sensors 122a-c. The sensors 122a-c may be passive infra-red (PIR) sensors, but other sensors may also be used for detecting the rodents 102a-c, e.g. radar sensors or vision-based sensors. In addition to using sensors that can directly detect the rodents, it is also possible to use sensors that can indirectly detect the rodents or that can provide information that can be used for determining the likelihood of rodent activity. Examples of such sensors are temperature sensors, microphones and hydrogen sulfide sensors. It has namely been found that the temperature, sound level and hydrogen sulfide level in the manholes 108a-c provides relevant information for determining whether or not rodents are present, and also to what extent rodents are present. By combining both direct sensors, such as PIR sensors, preferably two PIR sensors per monitoring device such that movement can be detected, and indirect sensors, such as temperature sensors, an improved detection of rodent activity can be achieved.

Even though illustrated as one integral device, the monitoring devices 106a-c may comprise a plurality of units. For instance, the temperature sensors, which may be part of the sensors 122a-c, may be placed in an end of the manhole 118a-c close to the laterals 112a-b at a distance from a main unit placed close to the manhole cover 114a-c. The temperature sensors may provide temperature data to the main unit either via wire or wireless.

The information captured via the sensors 122a-c can be transmitted from the monitoring devices 106a-c as senor data sets 124a-c. Even though illustrated as one sensor data set 106a-c per monitoring device 106a-c, in case several different types of sensors are used for the monitoring devices 106a-c, several different sensor data sets, one for each sensor type, can be sent from the monitoring devices 106a-c.

Each monitoring device 106a-c may have an identification code 126a-c, stored in the monitoring devices 106a-c. Instead of sending the identification code 126a-c and the sensor data set 126a-c as separate data sets, as illustrated, these may be combined into one and the same data set.

Via a data communications network 128, the identification code 126a-c and the sensor data sets 124a-c can be transferred to a server 130. Once received in the server 130, the identification code 126a-c and the sensor data sets 124a-c from the different monitoring devices 106a-c can be processed. Since locations of the different monitoring devices 106a-c can be provided to the server 132 upon installation of the monitoring devices 106a-c, and how the different manholes 108a-c are connected via laterals 112a-b can also be provided to the server 130, it is made possible to trace rodent activity in the sewage system 104.

For instance, by continuously receiving information about rodent activity in the different manholes 108a-c, it is made possible to predict rodent outbreaks, i.e. a rapid increase of rodents. The rodent outbreak may be caused by that conditions in the sewage system 104 is rapidly changing. For instance, in case sound levels are increasing due to a construction project, this may force rodent out of the sewage system 104 to the ground level 110. The rodent outbreak may also be caused by increased rodent populations. Even though such outbreak may have a development of weeks or months instead of minutes or hours, which may be the case when rodents are forced out of the sewage system due to increased sound levels, it is still possible to predict such outbreaks by using the system 100 illustrated in FIG. 1.

As illustrated in FIG. 1, a user device 132, herein exemplified by a computer, may be connected to the server 130. By having the user device 132 connected to the server 130, the rodent activity can be continuously monitored. In addition, by having the user device 132, it is made possible to make changes. For instance, in case the sewage system 104 is re-built such that, by way of example, additional laterals are formed, this information may be added by the operator via the user device 132.

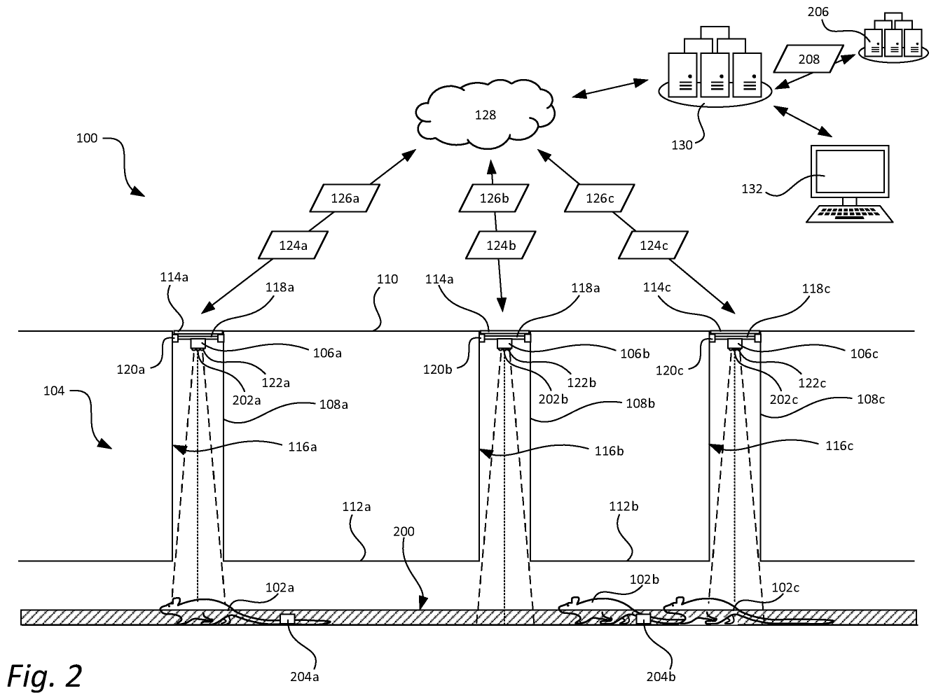

FIG. 2 illustrates the system 100 illustrated in FIG. 1, but unlike the system 100 illustrated in FIG. 1, the laterals 112a-b are partly filled with water. To monitor how much water that is present in the system 100, a water level 200 in the laterals 112a-b can be measured by using level sensors 202a-c forming part of the monitoring devices 106a-c. In addition, to have even better understanding of how the water in the laterals 112a-b is moving, flow sensors 204a-b may be provided in the laterals 112a-b. Instead of having the flow sensors 204a-b provided in the laterals112a-b, flow of the water may be determined remotely by non-contact flow sensors provided in the monitoring devices 106a-c. Such non-contact flow sensors, e.g. radar sensors, may benefit from surface changes of the water, but also in in tracing objects floating in the objects.

The sensor data 124a-c may thus also comprise water level information from the different manholes 108a-c. By having both sensor data linked to rodent activity as well as the water level, it is made possible to more accurately determine when and where rodent outbreaks are likely to occur. Water in the sewage system may namely force rodents out from the sewage system.

Another advantage with capturing water level information from different manholes continuously is that a broken lateral, causing either water inflow or water outflow, may be detected. Since a broken lateral may also result in that rodents move into the sewage system 104 or out from this, the detection of the broken lateral may be more accurate if taking into account both differences in water levels combined with differences in rodent activity.

Since the water level 200 in the sewage system 104 often depends on weather, a weather service server 206 may be linked to the server 130 such that weather forecast data 208 can be transferred to the server 130. By taking into account the weather forecast data 208, it is made possible to make even better predictions on when and where rodent outbreaks are likely. In addition to rain, wind may also have an effect on the water level 200 in the sewage system 104.

As described above, broken laterals may result in water inflow or water outflow, which as an effect may result in different water levels 200a-c in the different manholes 108a-c. A blockage in one of the laterals 112a,b may also result in different water levels in different manholes. In case of a blockage, the difference in water levels and rodent activity in the different manholes may change successively, while in case of a broken lateral, the change in water levels, but also rodent activity may change suddenly.

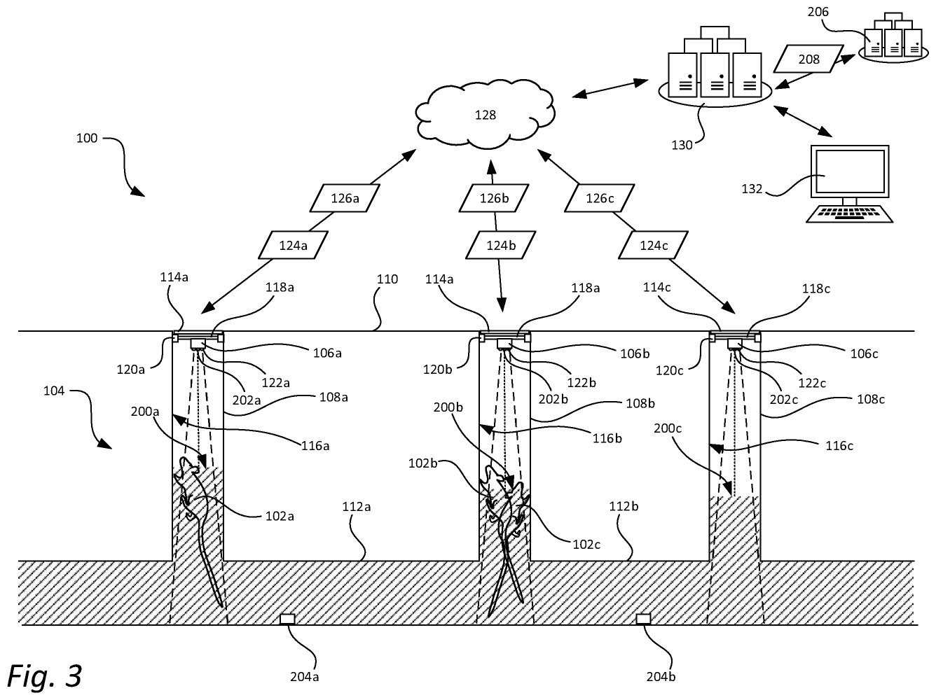

FIG. 3 illustrates the system 100 in a situation where the laterals 112a-b are filled with water and the rodents 102a-c are pushed up into the manholes 108a-c by the water. In the example illustrated, two rodents 102b-c are pushed up by the water into the second manhole 108b, one rodent 102a is pushed up in the first manhole 108a and no rodent is pushed up in the third manhole 108c. Due to the different number of rodents, reflected by rodent activity, in the different manholes, the sensor data 124a-c will indicate more rodent activity in the second manhole 108b, less rodent activity in the first manhole 108a and no rodent activity in the third manhole 108c. Based on this information, in case water levels are continuing to increase, the system 100 can predict that more rodents will be pushed up onto the ground level 110 via the second manhole 108b than the first manhole 108a, and also more rodents will be pushed up onto the ground level via the second manhole 108b than the third manhole 108c. In other words, by both registering rodent activity and water level in the manholes, it is made possible to reliably predict rodent outbreaks on ground level 110.

As described above with reference to FIGS. 2 and 3, the combination of the water level 200, 200a-c and the rodent activity in different manholes may be used for predicting when and where rodent outbreaks are likely to occur. When the water level 200 is not forcing the rodents into the manholes, as illustrated in FIG. 2, the water level may be less significant in determining when and where the rodent outbreak is likely to occur, while in case the rodents are pushed into the manholes 108a-c, as illustrated in FIG. 3, the water levels 200a-c may be more significant in determining when and where the rodent outbreak is likely to occur.

As illustrated in FIG. 3, the water levels 200a-c in the different manholes 108a-c may differ. One reason for this may be that water may leak out from the manholes in different extent and also in the laterals. In addition, there may be one or several blockages in the laterals that may result in different water levels in the manholes 108a-c. In case of rain, different water levels 200a-c may also be caused by that the rain are flowing into the different manholes 108a-c to different extent.

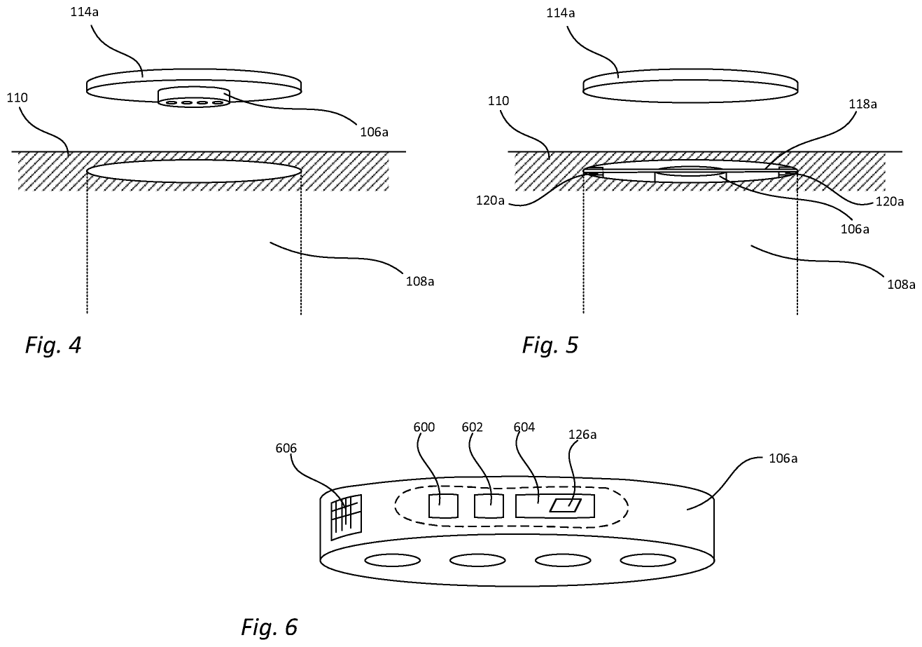

As discussed above, the monitoring devices 106a-c may be embodied in different ways. By way of example, a first embodiment is illustrated in FIG. 4. As illustrated, in this first embodiment, the monitoring device 106a may be attached to the manhole cover 114a. The attachment may be made in different ways. For instance, the manhole cover 114a may be provided with a threaded hole or any other attachment features such that the monitoring device 106a can be screwed on or in any other way be attached to the manhole cover 114a.

FIG. 5 illustrates a second embodiment of the monitoring device 106a by way of example. Instead of being attached to the manhole cover 114a, the monitoring device 106a is attached via the attachment element 118a, herein exemplified by a rod-shaped element, resting upon two protrusions 120a on the inside surface 116a of the manhole 108a.

FIG. 6 illustrates the monitoring device 106a in further detail. As illustrated, the monitoring device 106a may comprise a data communications module 600. Via the data communications module 600, the sensor data 124a and the identification code 126a may be transmitted to the server 130 as illustrated in FIG. 1. The sensor data 126a and the identification code 126a may be transmitted directly via e.g. 4G or other mobile data communications networks or it may be transmitted in a number of steps, e.g. in that data from a number of monitoring devices are collected and grouped before being sent to the server 130. The monitoring device 106a may further comprise a processor 602 and a memory 604. The memory 604 may hold the identification code 126a.

Further, the monitoring device 106a may be equipped with a tag 606 comprising a code, e.g. a printed code or a near field communication (NFC) code, linked to the identification code 124a. During installation, the operator may scan the code on the tag 606 by using a mobile phone or similar device equipped with camera. By doing so, a location of the mobile phone can be linked to the identification code 124a and sent to the server 130. Since the locations of the manholes 108a-c are known, the identification code 124a can in this way be linked to one of the manholes 108a-c. In case the location of the mobile phone does not correspond to any location of the manholes 108a-c, a notification can be sent to the operator asking him or her to manually assign the location of the manhole 108a in which the monitoring device 106a is placed.

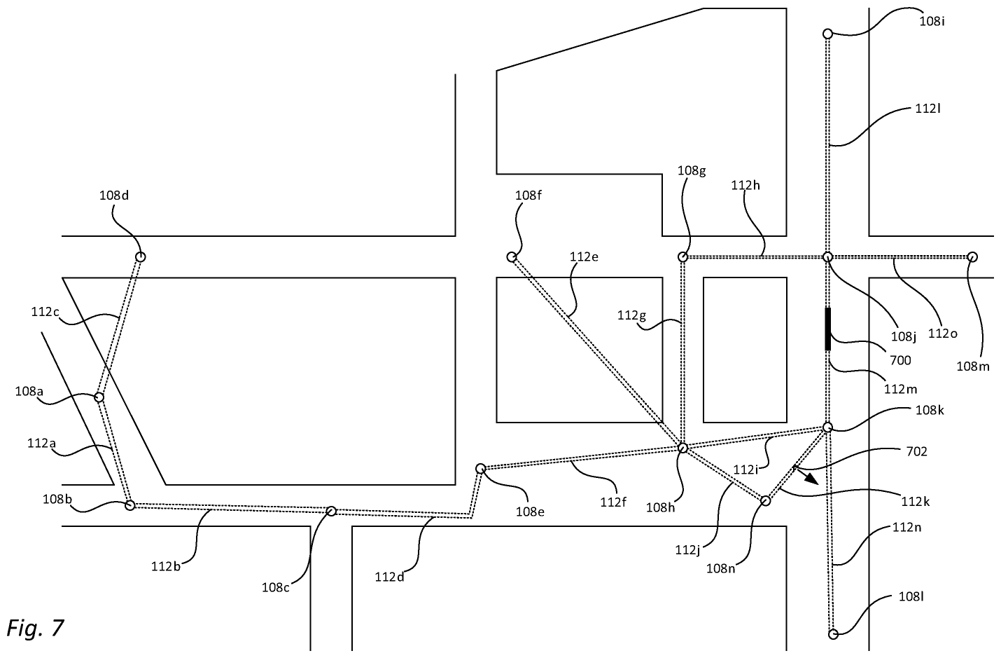

FIG. 7 illustrates by way of example the sewage system 104 combined with a city map. As illustrated, the sewage system 104 may follow roads in some parts of the city, but not in others. In addition, some of the manholes 108a-m may be dead ends with only one lateral 112a-o connected thereto. As illustrated, some of the laterals 112a-o may be straight while others may comprise turns.

In the illustrated example, a blockage 700 is presented in the lateral 112m connecting a tenth and eleventh manhole 108j-k to each other. Due to the blockage 700, the rodents 102a-c may choose to move via the sixth and seventh manhole 108g-h instead, which in such case will increase the rodent activity in these manholes. The blockage 700 may also result in that the rodents 102a-c choose to move on the ground level 110 due to the blockage 700. Thus, the blockage 700 may be detected in that increased rodent activity is detected in the sixth and seventh manhole 108g-h, and the blockage 700 may also increase the risk of having rodents on the ground level 110 in an area close to the tenth and eleventh manhole 108j-k.

Further, a leakage 702 is illustrated by way of example in an eleventh lateral 112k. The leakage 702 may result in that the rodents 102a-c are moving into buildings close to this eleventh lateral 112k since a new way is provided as an effect of the leakage 702. The leakage 702 may be detected in that less rodent activity is detected in the eleventh or fourteenth manhole 108k,n, or in that the difference in rodent activity between the two manholes is increased.

By having Machine Learning (ML) models, Artificial Intelligence (AI) models or statistical models running on the server 130, the data collected over time in combination with actual rodent outbreaks, leakages, blockages, etc. may be used for training these models. Once trained, these may be used for predict rodent outbreaks, leakages, blockages etc.

With PIR sensors and other sensors commonly used today, individual rodents are not identified. However, if using more advanced sensor, instead of detecting rodent activity in general, individual rodents may be traced between the different manholes. In doing so, even more accurate predictions may be achieved. The individual rodents may be detected based on size, movement pattern, coloring, anatomical features, e.g. tail to body relationship, etc.

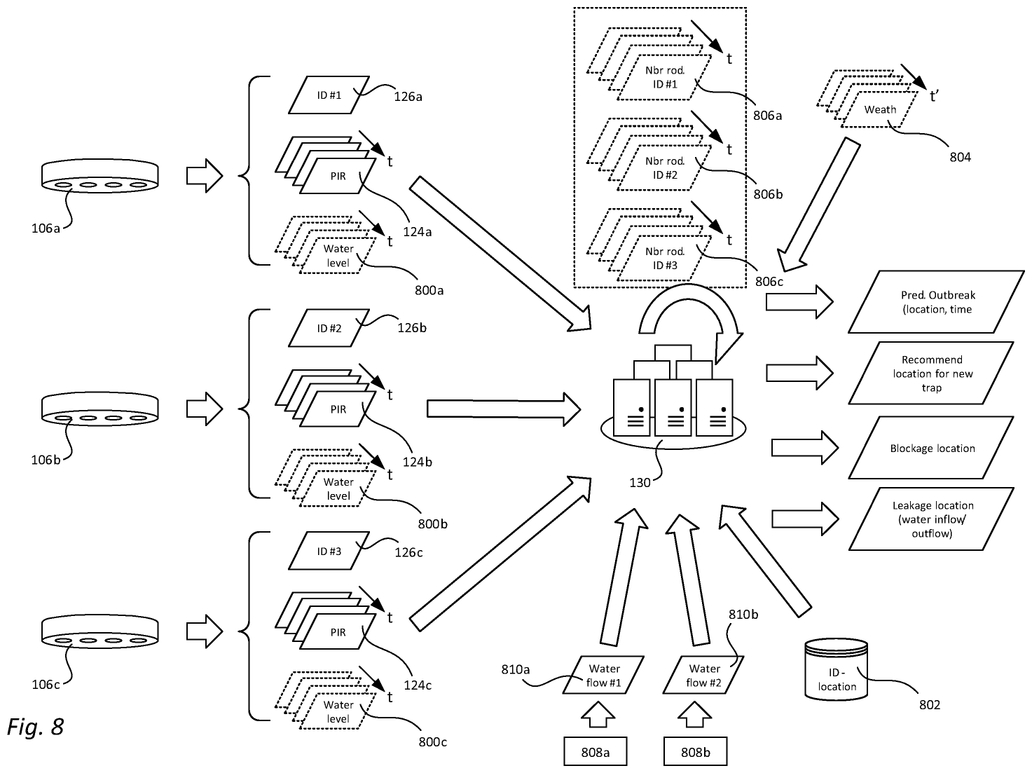

FIG. 8 illustrates how data is transferred and processed to arrive in a rodent outbreak prediction, i.e. when and where in the city it is likely that rodents will appear, a recommendation of location for a new trap, a blockage location and/or a leakage location.

As discussed above, each monitoring device 106a-c may capture sensor data 126a-c, e.g. PIR sensor data, indicating rodent activity and also, optionally, water level sensor data 800a-c indicating the water level 200a-c in the manholes 108a-c.

To associate the identification codes 126a-c to locations, an ID-location database 802 may be used. As described above, during installation of the monitoring device 106a-c, the identification code 126a-c may be linked to a location, i.e. a geographical position. This location may in turn be used for linking the monitoring device 106a-c and the sensor data 124a-c from this to a particular manhole. By having information on how the different manholes 108a-n and laterals 112a-o are linked to one another, this information may also be taken into account and provided via the ID-location database 802.

Optionally, weather forecast data 208 may be provided. The weather forecast data 208 is unlike the other data related to a coming period of time, herein denoted t′.

In addition to the weather forecast data 804, actual weather data may also be provided and taken into account, even though not illustrated.

Optionally, the sensor data 124a-c may be processed in two steps; first determining rodent activity data sets 806a-c and second using the rodent activity data sets 806a-c for predicting rodent outbreaks, recommending location of new trap and/or localizing leakage or blockage. The rodent activity may as illustrated by number of rodents detected during a time interval, but it may also be a general measure of detected activity.

Optionally, flow sensors 808a-b may be provided such that water flow can be registered in the laterals 112a-b. Water flow data 810a-b obtained via the flow sensors 808a-b may be input to the server 130 and taken into account when e.g. identifying the underground leakage 702.

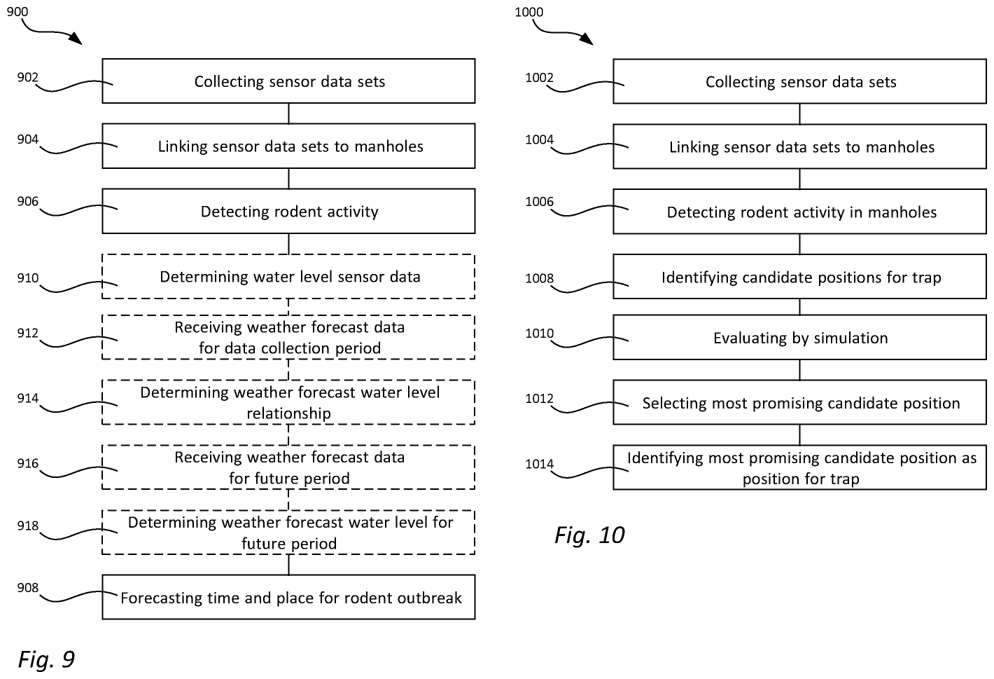

FIG. 9 is a flowchart illustrating a method 900 for forecasting a rodent outbreak. In a first step 902, sensor data sets 124a-c can be collected from a plurality of monitoring devices 106a-c placed in the manholes 108a-c or the laterals 112a-b of the sewage system 104, during a data collection period comprising a plurality of sample time slots. In a second step 904, the sensor data sets 124a-c can be linked to the manholes 108a-c. In a third step 906, the rodent activity 806a-c in each manhole 108a-c during the sample time slots of the data collection phase can be detected. In a fourth step 908, for a future period, based on the rodent activity 806a-c determined in the manholes 108a-c during the data collection phase, when and where rodents 102a-c are forced out of the sewage system 104 can be forecasted.

Optionally, in a fifth step 910 the water level sensor data 800a-c in the manholes 108a-c during the data collection period may be determined. The fourth step 908 may be based on the rodent activity 806a-c detected in the manholes 108a-c in combination with the water level sensor data 800a-c determined during the data collection period.

Optionally, in a sixth step 912 the weather forecast data 208 may be received during the data collection period, and in a seventh step 914 a weather forecast-water level relationship between the weather forecast data 208 and the water level sensor data 800a-c in the manholes 108a-c during the data collection period can be determined. In an eighth step 916 the weather forecast data 208 may be received for the future period. In a ninth step 918 weather forecast water levels for the future period can be determined based on the weather forecast data 208 for the future period and the weather forecast-water level relationship. The fourth step 908 may, for the future period, forecast when and where the rodents 102a-c are forced out of the sewage system 104 based on the rodent activity 806a-c detected in the manholes 108a-c during the data collection period in combination with the weather forecast water levels determined based on the weather forecast data 208 for the future period.

FIG. 10 is a flowchart illustrating a method 1000 for identifying a position for placing a trap in the sewage system 104. In a first step 1002 the sensor data sets 124a-c can be collected from the plurality of monitoring devices 106a-c placed in the manholes 108a-c of the sewage system 104, during a data collection period comprising a plurality of sample time slots. In a second step 1004, the sensor data sets 124a-c can be linked to the manholes 108a-c. In a third step 1006, the rodent activity 806a-c can be detected in each manhole 108a-c during the sample time slots of the data collection phase. In a fourth step 1008, a least two candidate positions for placing a trap in the sewage system 104 can be identified. In a fifth step 1010, effects on rodent populations in the sewage system with the trap placed in the at least two candidate positions for a future period can be evaluated by using simulation. In a sixth step 1012 a most promising candidate position of the at least two candidate positions by comparing the effects associated with the at least two candidate positions with pre-set selection requirements can be selected. In a seventh step 1014 the most promising candidate position can be identified as the position for placing the trap.

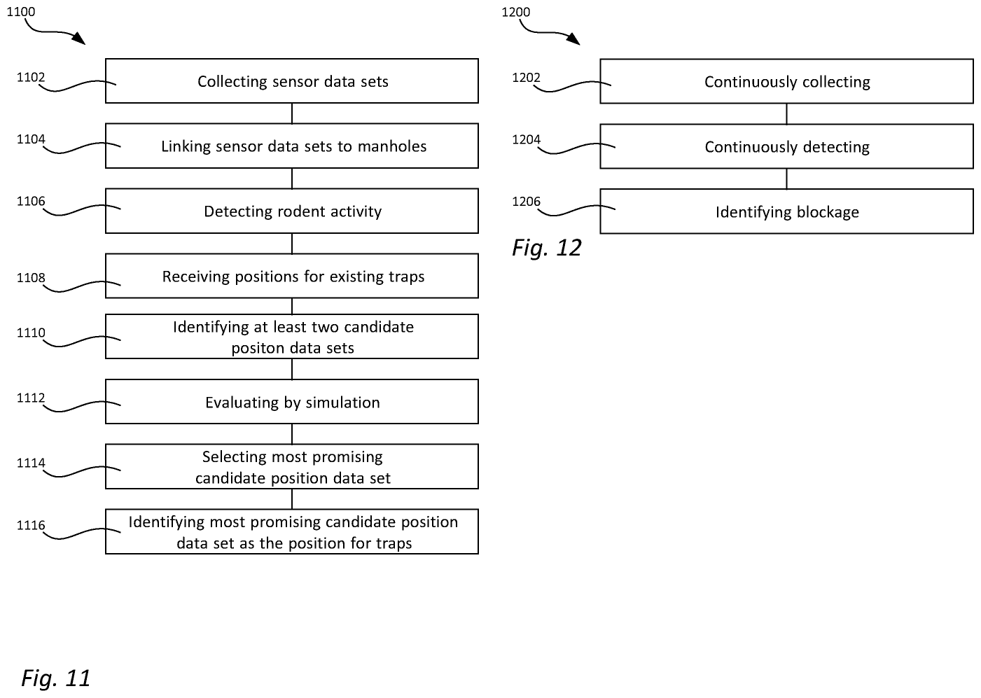

FIG. 11 is a flowchart illustrating a method 1100 for identifying positions for existing traps in the sewage system 104. In a first step 1102 the sensor data sets 124a-c can be collected from the plurality of monitoring devices 106a-c placed in the manholes 108a-c of the sewage system 104, during the data collection period comprising the plurality of sample time slots. In a second step 1104, the sensor data sets 124a-c can be linked to the manholes 108a-c. In a third step 1106, the rodent activity 806a-c in each manhole 108a-c can be detected during the sample time slots of the data collection phase. In a fourth step 1108, positions for the existing traps may be received. In a fifth step 1110, at least two candidate position data sets for placing the existing traps in the sewage system 104 can be identified. In a sixth step 1112, effects on the rodent populations in the sewage system with the traps placed in the at least two candidate position data sets for a future period can be evaluated by simulation. In a seventh step 1114, a most promising candidate position data set of the at least two candidate position data sets can be selected by comparing the effects associated with the at least two candidate position data sets with pre-set selection requirements. In an eighth step 1116, the most promising candidate position data set can be identified as the positions for the existing traps.

FIG. 12 is a flowchart illustrating a method 1200 for identifying the blockage 700 in the sewage system 104, wherein the sewage system 104 comprises a plurality of manholes 108a-c connected by the laterals 112a-b. In a first step 1202, the sensor data sets 124a-c can be continuously collected from the plurality of monitoring devices 106a-c placed in the manholes 108a-c. In a second step 1204, the rodent activity 806a-c in each manhole 108a-c can be detected. In a third step 1206, the blockage 700 in the lateral 112a-b connecting two of the manholes can be identified by detecting a decreasing rodent activity in at least one manhole 108a-c connected to the lateral 112a-b.

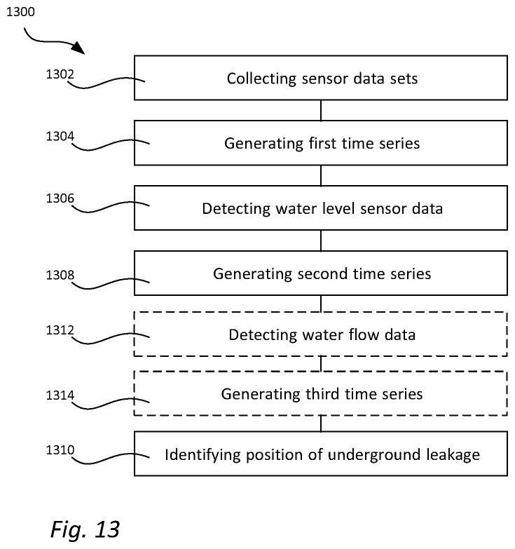

FIG. 13 is a flowchart illustrating a method 1300 for identifying a position of the underground leakage 702 in the sewage system 104. The sewage system 104 may comprise the plurality of manholes 108a-c connected by the laterals 112a-b. In a first step 1302, the sensor data sets 124a-c can be collected from the plurality of monitoring devices 106a-c placed in the manholes 108a-c over a period of time. In a second step 1304, a first time series providing the rodent activity 806a-c in each manhole 108a-c can be generated by using the sensor data sets 124a-c over the period of time. In a third step 1306, the water level sensor data 800a-c for each manhole 108a-c can be detected. In a fourth step 1308, a second time series providing water levels in each manhole can be generated by using the water level sensor data 800a-c over the period of time. In a fifth step 1310, the position of the underground leakage 702 in the sewage system 104 can be identified by combining the first and second time series.

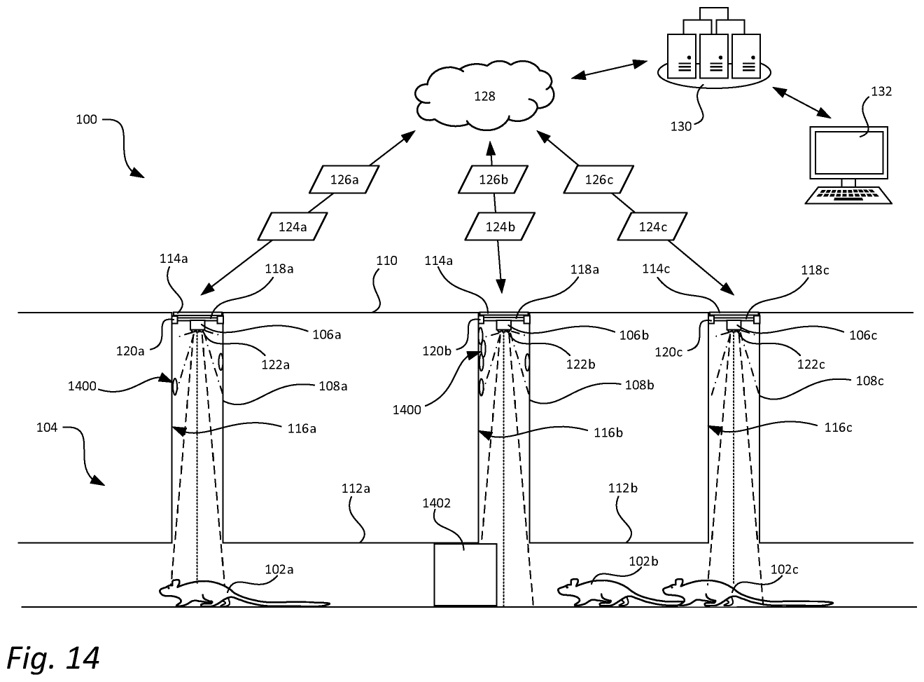

FIG. 14 illustrates the system 100 illustrated in FIG. 1 and described above with the addition that the monitoring devices 106a-c are configured to detect rodent activity as well as insect activity. As illustrated and as described above, the monitoring devices 106a-c may be placed under the manhole covers 114a-c. In such position, the rodents 102a-c in the laterals 112a-c, but also insects 1400, such as American cockroaches, residing below the manhole covers 114a-c in the manholes 108a-c can be detected. Even though not illustrated, the monitoring devices 106a-c may also be configured to solely detect the insects 1400. The sensors 122a-c of the monitoring devices 106a-c may include microphones or other sound capturing devices that can be used both for detecting the rodents 102a-c and the insects 1400. There may however also be sensors 122a-c specifically adapted for detecting the insects 1400 and the rodents 102a-c, respectively.

In FIG. 14 it is also illustrated that a trap 1402 for rodents 102a-c can be placed in the laterals 112a-b. By measuring the rodent activity in different manholes 108a-c, it can be determined where to place the trap 1402 in the sewage system 104 to efficiently reduce the number of rodents 102a-c. Put differently, once busy rodent paths in the sewage system 104 has been identified by using the rodent activity data, a notification can be transmitted to an operator to place the trap 1402 in one of the laterals 112a-b forming part of this busy path.

In addition to determine where to place the trap 1402, efficiency of the trap 1402 can also be determined. By measuring the rodent activity after the trap 1402 has been placed in the sewage system 104, an effect of the rodent activity in total can be determined and it can also be determined how rodent movements within the sewage system 104 have been changed.

The trap 1402 may be arranged such that the rodent 102a-c is killed by a spring-loaded spear shooting downwards once the rodent 102a-c is detected in the trap 1402. Since water is flowing in the sewage system 104, the rodent 102a-c can be flushed out from the sewage system 104 after being killed in the trap 1402. In case one or several sensors are being used such that live rodents can be distinguished from dead rodents, efficiency of the trap 1402 can be determined by using monitoring devices 106a-c placed downstream the trap 1402. For instance, by using a combination of radar sensors and microphones it may be possible to distinguish the live rodents from the dead rodents.

The triggering of the trap 1402 may be communicated via the monitoring device 106b to the server 130. Another option, in case e.g. the trap 1402 is not provided with data communication capability, is that the triggering of the trap 1402 is recognized by sound. For instance, if the sensors 122b of the monitoring device 106b comprises the microphone, the sound of the trap 1402 being triggered can be captured and thereafter processed by the monitoring device 106b and/or the server 130 such that it can be concluded whether or not the trap has been triggered. By way of example, the shooting of the spring-loaded spear gives rise to a distinct sound that can be recognized when processing audio data captured via the microphone.

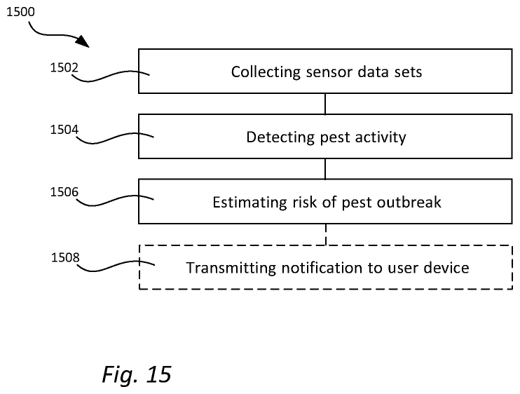

FIG. 15 is a flowchart illustrating a method 1500 for predicting a pest outbreak. Sensor data may be collected 1502 from at least one monitoring device placed in the manhole of the sewage system, during the data collection period comprising a plurality of sample time slots. Pest activity, such as insect activity, in the manhole may be detected 1504 during the sample time slots of the data collection phase, and, for a future period, based on the pest activity determined in the manhole during the data collection phase, a risk of a pest outbreak can be estimated 1506. Optionally, in case the risk of the pest outbreak is above a threshold, transmitting 1508 a notification to a user device such that actions to mitigate or avoid the risk can be taken. Both the threshold and also the actions communicated to the user device may be determined by using an AI and/or ML model trained with data from a large base of monitoring devices in sewage systems.

As a complement or as an alternative to the sensors in the monitoring devices, sensors may also be provided in the traps in the sewage systems. These traps may include rodent traps placed in the laterals, but also insect traps placed in the manholes.

As illustrated in FIG. 14, both rodent outbreaks and insect outbreaks can be estimated by the monitoring devices 106a-c. Even though not illustrated, the weather forecast data can also be used for more accurately forecast the risk, or estimate the risk for the future period. By taking into account the weather forecast data for the data collection period, or if available, actual weather data for the data collection period, as well as weather forecast data for the future period, an improved risk estimation can be achieved. Further, in case the risk for the pest outbreak is estimated to be above a threshold, a notification can be sent from the server 130, the monitoring devices 106a-c or other part of the system to the user device 132 that an action is to be made to avoid the outbreak. Taking into account weather data may be of particular relevance for systems arranged to monitor pest activity in the sewage system. By way of example, heavy rain may for instance have the effect that the laterals between different manholes are completely filled with water, thereby having a direct effect on how the rodents can move within the sewage system. For insects, since a space below the manhole cover is a constrained space, the temperature in this space may quickly increase if the manhole cover is exposed to direct sunlight.

From the description above follows that, although various embodiments of the invention have been described and shown, the invention is not restricted thereto, but may also be embodied in other ways within the scope of the subject-matter defined in the following claims.

1. A system for monitoring rodents in a sewage system, the system for monitoring in a sewage system comprising:
a plurality of monitoring devices placed in manholes of a sewage system, wherein each of the plurality of monitoring devices comprises:
a sensor configured to detect rodents in the sewage system and to generate a sensor data set;
a memory configured to hold an identification code; and
a data communications module;
a server comprising a data communications module communicatively connected to the data communication module of each of the plurality of monitoring devices, wherein the server is configured to receive, from each of the plurality of monitoring devices, the sensor data set and the identification code, and based on the sensor data set and the identification code identify how populations of rodents move in the sewage system.

2. The system for monitoring in a sewage system according to claim 1, wherein the identification code of one of the plurality of monitoring devices is linked to a position data set, wherein the position data set comprises information about a geographical position of the one of the plurality of monitoring devices.

3. The system for monitoring in a sewage system according to claim 2, wherein the one of the plurality of monitoring devices is provided with a tag provided with a code linked to the identification code of the one of the plurality of monitoring devices.

4. The system for monitoring in a sewage system according to claim 1, wherein each of the plurality of monitoring devices comprises a second sensor that is placed at a distance from the sensor such that a direction of movement of the rodents can be determined.

5. The system for monitoring in a sewage system according to claim 1, wherein the sensor comprises a radar sensor.

6. The system for monitoring in a sewage system according to claim 1, wherein the sensor comprises a temperature sensor.

7. The system for monitoring in a sewage system according to claim 1, wherein the sensor comprises a flow sensors arranged in a lateral pipe.

8. The system for monitoring in a sewage system according to claim 1, wherein the sensor comprises a hydrogen sulfide sensor.

9. The system for monitoring in a sewage system according to claim 1, wherein, for each of the plurality of monitoring devices, the sensor a is configured as a level sensor such that a water level in a manhole of the sewage system is detected.

10. A monitoring device for monitoring rodents in a sewage system, the monitoring device comprising:
a sensor configured to detect rodents in a sewage system and to generate a sensor data set;
a memory configured to hold an identification code; and
a data communications module communicatively connected to a server.

11. The monitoring device according to claim 10, further comprising an attachment element arranged to interact with an inside surface of a manhole of the sewage system or an underside of a manhole cover arranged to cover the manhole.

12. The monitoring device according to claim 11, wherein the attachment element is a rod-shaped element arranged to rest on a first protrusion and a second protrusion provided on the inside surface of the manhole.

13. The monitoring device according to claim 11, wherein the sensor is configured as a level sensor such that a water level in the manhole is detected.

14. A method for predicting a rodent outbreak in a city, the method comprising:
collecting sensor data sets from a plurality of monitoring devices placed in manholes or lateral pipes of a sewage system;
during a data collection period comprising a plurality of sample time slots, linking the sensor data sets to the manholes;
detecting rodent activity in each of the manholes during the plurality of sample time slots of the data collection period; and
forecasting, for a future period, based on the rodent activity detected in each of the manholes during the data collection period, when and where rodents are forced out of the sewage system.

15. The method according to claim 14, further comprising determining water level sensor data in the manholes during the data collection period; and
wherein the forecasting, for the future period, when and where the rodents are forced out of the sewage system is based on the rodent activity detected in each of the manholes in combination with the water level sensor data determined during the data collection period.

16. The method according to claim 15, further comprising:
receiving weather forecast data during the data collection period; determining a weather forecast-water level relationship between the weather forecast data and the water level sensor data detected in each of the manholes during the data collection period;
receiving weather forecast data for the future period; and
determining weather forecast water levels for the future period, based on the weather forecast data for the future period and the weather forecast-water level relationship; and
wherein the forecasting, for the future period, when and where the rodents are forced out of the sewage system is based on the rodent activity detected in each of the manholes during the data collection period in combination with the weather forecast water levels determined based on the weather forecast data for the future period.

17. A method for identifying a position for placing a trap in a sewage system, the method comprising:
collecting sensor data sets from a plurality of monitoring devices placed in manholes of a sewage system, during a data collection period comprising a plurality of sample time slots;
linking the sensor data sets to the manholes;
detecting rodent activity in each of the manholes during the plurality of sample time slots of the data collection period;
identifying at least two candidate positions for placing a trap in the sewage system;
evaluating, by simulation, effects on rodent populations in the sewage system for the trap placed in the at least two candidate positions for a future period;
selecting a most promising candidate position of the at least two candidate positions by comparing effects associated with the at least two candidate positions with pre-set selection requirements; and
identifying the most promising candidate position as the position for placing the trap.

18. A method for identifying positions for existing traps in a sewage system, the method comprising:
collecting sensor data sets from a plurality of monitoring devices placed in manholes of a sewage system, during a data collection period comprising a plurality of sample time slots;
linking the sensor data sets to each of the manholes;
detecting rodent activity in each of the manholes manhole during the plurality of sample time slots of the data collection period;
receiving positions for existing traps,
identifying at least two candidate position data sets for placing the existing traps in the sewage system;
evaluating, by simulation, effects on rodent populations in the sewage system with the existing traps placed in the at least two candidate position data sets for a future period;
selecting most promising candidate position data sets of the at least two candidate position data sets by comparing effects associated with the at least two candidate position data sets with pre-set selection requirements; and
identifying the most promising candidate position data sets as the positions for the existing traps.

19. A method for identifying a blockage in a sewage system, wherein the sewage system comprises a plurality of manholes connected by lateral pipes, the method comprising:
continuously collecting sensor data sets from a plurality of monitoring devices placed in the plurality of manholes;
continuously detecting rodent activity in each of the plurality of manholes; and
identifying a blockage in one of the lateral pipes connecting two of the plurality of manholes by detecting a decreasing rodent activity in at least one of the two of the plurality of manholes connected to the one of the lateral pipes.

20. A method for identifying a position of an underground leakage in a sewage system (104), the sewage system comprising a plurality of manholes connected by lateral pipes, the method comprising:
collecting sensor data sets from a plurality of monitoring devices placed in the plurality of manholes over a period of time;
generating a first time series providing rodent activity in each of the plurality of manholes using the sensor data sets over the period of time;
detecting water level sensor data for each of the plurality of manholes;
generating a second time series providing water levels in each of the plurality of manholes using the water level sensor data over the period of time; and
identifying a position of an underground leakage in the sewage system by combining the first time series and the second time series.

21. The method according to claim 20, further comprising:
detecting water flow data in the lateral pipes laterals by using flow sensors placed in the lateral pipes;
generating a third time series providing water flows in the lateral pipes using the water flow data over the period of time; and
wherein the identifying the position of the underground leakage in the sewage system is made by combining the first time series, the second time series, and the third time series.

22. A method for predicting a pest outbreak, the method comprising:
collecting sensor data sets from at least one monitoring device placed in a manhole of a sewage system, during a data collection period comprising a plurality of sample time slots;
detecting pest activity in the manhole during the plurality of sample time slots of the data collection period; and
estimating, for a future period, based on the pest activity detected in the manhole during the plurality of sample time slots of the data collection period, a risk of a pest outbreak.

23. The method according to claim 22, wherein the pest outbreak comprises a rodent outbreak and/or an insect outbreak, the pest activity comprises rodent activity and/or insect activity, and the sensor data sets comprise temperature data, water flow data and/or water level sensor data.

24. The method according to claim 22, further comprising in case the risk of the pest outbreak is above a threshold, transmitting a notification to a user device such that actions can be made to mitigate the risk of the pest outbreak.
